(19) United States
(12) Patent Application Publication
(10) Pub. No.: US 2025/0340330 A1
(43) Pub. Date: Nov. 6, 2025

(54) BEVERAGE AND ACCESSORY STORAGE APPARATUS

(71) Applicant: Peter Ellman, Pinehurst, NC (US)

(72) Inventor: Peter Ellman, Pinehurst, NC (US)

(21) Appl. No.: 18/651,822

(22) Filed: May 1, 2024

(51) Int. Cl. B65D 25/22; B32B 3/08; B32B 5/02; B65D 81/38

(52) U.S. Cl. CPC B65D 25/22; B32B 3/08; B32B 5/02; B65D 81/3876; B32B 2262/02; B32B 2307/744; B32B 2439/00

(57) ABSTRACT

A beverage and accessory caddy apparatus optimized to engage an external surface, and methods of fabricating and implementing same, are disclosed. In some implementations, a substantially planar sheet of material may support both a storage component which accommodates an item to be stored and a weighting component which provides ballast to secure the sheet when in use. An apparatus such as illustrated and described may not only provide ample storage for beverages and desired accessories, but also may also be used to engage structural members of any number of vehicles, furniture items or other articles of manufacture, and even natural structures.

### CROSS-REFERENCE TO RELATED APPLICATIONS

Not Applicable.

### FIELD OF THE DISCLOSURE

Aspects of the disclosed subject matter relate generally to beverage and other accessory holders, and more particularly to a flexible, portable caddy and storage apparatus for beverages and other accessories, as well as methods of fabricating and implementing same.

### BACKGROUND

While beverage and small item storage options are ubiquitous in some contexts, they are lacking in others. For example, automobiles and trucks often have cup holders in the passenger compartment for securing beverage containers such as mugs, cans, bottles, and cups while the vehicles are in motion and the operators' or passengers' hands are otherwise occupied. Similarly, consoles, boxes, molded depressions, or compartments are often integrated into the structure of such a vehicle and have utility in restricting unwanted movement of small items (such as maps, flashlights or other hand tools, wireless telephones, notepads and pens, and the like) that might otherwise be free to move around in an undesirable manner as the vehicle is in motion. Portable chairs of the type used for beach, patio, or poolside lounging, sporting events, camping trips, and other applications often have integrated cup holders or pockets for light items such as sun screen lotion, reading material and glasses, fishing tackle, and similar objects.

On the other hand, many vehicles, portable furniture, and other devices do not include integrated storage apparatus or compartments for accommodation of beverages, tools, etc. that may be desirable for use in connection with the activities for which the vehicle, furniture, or device is designed. In some circumstances, a vehicle operator may be forced to hold, support, or otherwise brace loose items to prevent unwanted movement, or may be otherwise inclined to forego access to desired beverages or other items, instead placing them in a secure location that is out of reach.

There is, therefore, a continuing and heretofore unmet need for an improved beverage and accessory storage apparatus (or “caddy”) that is portable and may be used for various applications. Such an apparatus may not only provide ample storage for beverages and desired accessories, but also may also be used to engage structural members of any number of vehicles, furniture items or other articles of manufacture, and even natural structures, making it suitable for a variety of indoor and outdoor activities in numerous contexts. In some implementations, a storage apparatus as set forth herein may be of sufficiently flexible construction such that it may be folded, wadded, or rolled when not in use.

### SUMMARY OF THE DISCLOSURE

The following presents a simplified summary of the disclosure in order to provide a basic understanding of some aspects of various embodiments disclosed herein. This summary is not an extensive overview of the disclosure. It is intended neither to identify key or critical elements of the disclosed embodiments nor to delineate the scope of those embodiments. Its sole purpose is to present some concepts of the disclosed subject matter in a simplified form as a prelude to the more detailed description that is presented later.

The present disclosure describes a beverage and accessory storage apparatus generally employing a sheet of material configured and operative to support one or more storage components, each of which may be appropriately dimensioned to carry a beverage container, tool, electronic device, or other item. In the context of this description, such a sheet of material may be embodied in or comprise any of various fabrics, plastics, composites, or other natural or synthetic materials substantially as set forth below. In some implementations, for instance, the sheet may be flexible enough to be rolled or folded when not in use. It will also be appreciated that the storage components may be integrated with a structure of the sheet or be selectively removable or replaceable, and that they may vary in size, shape, material strength, and dimensional characteristics based upon, among other factors, the size and approximate weight of the beverage container or other item intended to be supported.

In accordance with one aspect of the disclosed subject matter, for example, an apparatus for storage of beverages and other accessories may generally comprise: a sheet of material having a top end, a bottom end opposed to the top end, a left side, and a right side opposed to the left side, the sheet defining a front surface and a back surface, the back surface opposed to the front surface and operative to engage an external structure during use of the apparatus; a storage component disposed at a location on the front surface proximate to the bottom end and operative selectively to store an item during use of the apparatus; and a weighting component disposed proximate to one of the top end or the bottom end and operative to provide a force to the sheet when the back surface is made to bear on the external structure; wherein the sheet is sufficiently pliable to flex in relation to the external structure under the force provided by the weighting component.

Implementations are disclosed wherein a material used for the sheet comprises one of cloth, synthetic fabric, composite material, rubber, or a synthetic rubber (and may be water-resistant or waterproof). Additionally or alternatively, the sheet may comprise more than one layer of material. In some implementations of an apparatus, the back surface of the sheet may comprise a slip-resistant material, the front surface of the sheet may comprise a synthetic fabric material, or both of these options may be implemented simultaneously.

Various alternatives of apparatus are disclosed wherein the storage component is sized and dimensioned to accommodate a beverage container, wherein the storage component comprises an insulating material, and wherein the storage component comprises a mesh material, among other options, either individually or in combination.

In some implementations, the weighting component may extend substantially from the left side to the right side of the sheet. Apparatus are disclosed wherein one of the storage component and the weighting component is selectively removable. In accordance with the present disclosure, the sheet may be substantially rectangular in a front elevation view, substantially elliptical in a front elevation view, or of some other shape (which may or may not be symmetrical) in a front elevation view.

In accordance with another aspect of the disclosed subject matter, an apparatus for storage of beverages and other accessories may generally comprise: a sheet of material having a top end, a bottom end opposed to the top end, a left side, and a right side opposed to the left side, the sheet defining a front surface and a back surface, the back surface opposed to the front surface and operative to engage an external structure during use of the apparatus; a storage component disposed at a location on the front surface proximate to the bottom end and operative selectively to store an item during use of the apparatus; and a first weighting component disposed proximate to the top end and a second weighting component disposed proximate to the bottom end, the first and second weighting components, respectively, operative to provide a respective force to the sheet when the back surface is made to bear on the external structure; wherein the sheet is sufficiently pliable to flex in relation to the external structure under the respective force provided by each of the respective first and second weighting components.

Such arrangements employing more than one weighting component are disclosed wherein a material used for the sheet comprises one of cloth, synthetic fabric, composite material, rubber, or a synthetic rubber. As set forth herein, implementations are contemplated wherein the back surface of the sheet comprises a slip-resistant material. In some apparatus, the storage component is sized and dimensioned to accommodate a beverage container, though alternative shapes and sizes of storage components are set forth in detail below.

Apparatus are disclosed wherein one of the first weighting component and the second weighting component extends substantially from the left side to the right side of the sheet. In some disclosed implementations, one of the storage component, the first weighting component, and the second weighting component is selectively removable (though it will be appreciated that all of such components may be selectively removable in some arrangements). As noted above and set forth in detail below, apparatus are disclosed wherein the sheet is substantially rectangular or elliptical in a front elevation view, though the disclosure is not so limited.

In accordance with yet another aspect of the disclosed subject matter, a method of fabricating a storage apparatus may generally comprise: providing a sheet of material defining a front surface and a back surface, the back surface opposed to the front surface; selectively securing a storage component to the first surface at a location selected to position an item to be stored in a predetermined orientation during use of the apparatus; and selectively securing a weighting component to the sheet at a location selected to provide a force to the sheet when the back surface is made to bear on an external structure; wherein the providing a sheet comprises selecting a material that is sufficiently pliable to allow the sheet to flex in relation to the external structure under the force provided by the weighting component.

As set forth below, the weighting components may comprise magnetic material, sand, gravel or other aggregate material, or even liquid, in some instances, and may be interchangeable (in the case of selectively removable embodiments) or resealable such that ballast material may be removed, augmented, or replaced as desired for a particular application.

It is noted that various aspects and features of some disclosed implementations may be employed readily with other aspects and features disclosed in connection with other implementations. The foregoing and other aspects of various disclosed embodiments will be apparent through examination of the following detailed description thereof in conjunction with the accompanying drawing figures, in which like reference numerals are used to represent like components throughout, unless otherwise noted.

### DESCRIPTION OF THE DRAWING FIGURES

FIG. 1 is a perspective view of one implementation of a beverage and accessory storage apparatus in an extended state when not in use;

FIG. 2 is a perspective view of the apparatus of FIG. 1 positioned for use in connection with an external structure;

FIG. 3 is a front elevation view of the apparatus of FIG. 1;

FIG. 4 is a back elevation view of the apparatus of FIG. 1;

FIG. 5 is a side cross-sectional view of the apparatus of FIG. 1 taken on the line 5-5 in FIG. 3;

FIG. 6 is a perspective view of the apparatus of FIG. 1 in use in connection with an external structure (not shown), and also depicting various items that may be stored;

FIG. 7 is a partially exploded perspective view of the apparatus of FIG. 6 and the various items that may be stored;

FIG. 8 is a perspective view of the apparatus of FIG. 1 illustrated in a state suitable for storage;

FIG. 9 is a perspective view of another implementation of a beverage and accessory storage apparatus positioned for use in connection with an external structure (not shown), and also illustrating a selectively attachable storage component;

FIGS. 10 through 12 are front elevation views of several implementations of a beverage and accessory storage apparatus in an extended state when not in use, and also illustrating various shapes, alternatives, and component configurations; and

FIG. 13 is a simplified functional flow diagram illustrating aspects of one implementation of a method of fabricating a beverage and accessory storage apparatus.

### DETAILED DESCRIPTION

Certain aspects and features of the disclosed subject matter may be further understood with reference to the following description and the appended drawing figures. In operation, a beverage and accessory storage apparatus generally comprises a sheet of material that may be made to engage or otherwise bear upon a surface of a vehicle, a piece of furniture, a fence, railing, stem or retaining wall, or other structure or article of manufacture, or even natural structures such as boulders, ledges, tree stumps or branches, etc. The sheet may selectively bear or otherwise support cup or beverage holders, pockets, or fastening loops (or perhaps a combination of these or other storage components or retention elements) in a location and orientation convenient for retrieval by a user. Specifically, the present disclosure provides for a flexible or pliable sheet that may be made to engage any number of support surfaces while still orienting a beverage or other item for easy retrieval, and may be sufficiently flexible or pliable to allow for folding, wadding, or rolling of the apparatus when not in use.

The following detailed description and the appended drawing figures describe and illustrate some implementations of such an apparatus (and a method of fabricating same) for the purpose of enabling one of ordinary skill in the relevant art to make and use these implementations. As such, the detailed description and drawing figures are purely illustrative in nature and are in no way intended to limit the scope of the disclosure in any manner. It should also be understood that the drawing figures are not necessarily to scale and that in certain instances, details which are not necessary for an understanding of the disclosure, such as details of material hardness, strength, and elasticity or other parameters, may have been omitted from the drawing figures or the written description for clarity. As noted above, in the accompanying drawing figures, like reference numerals are used to represent like components throughout, unless otherwise noted.

The features of some implementations are described below with reference to illustrations of apparatus, components, and structural members, per se, according to the disclosed implementations. As noted above, it will be understood that individual elements, details, or structural components depicted in the drawing figures, as well as certain combinations of elements depicted in the drawing figures, may be augmented, supplemented, or replaced as a matter of design choice, and may be application-specific. This will be especially apparent in the discussion of the placement of physical storage components which embody the apparatus or parts thereof, as well as in the choice of materials and interconnecting components such as snaps, buttons, zippers, and the like.

In that regard, it is noted that aspects of the present apparatus and method may be designed, tested, refined, modified, or implemented with the assistance of or in connection with one or more computing devices, including one or more servers, one or more client terminals, including computer terminals, a combination thereof, or on or facilitated by any of myriad computing devices currently known in the art, including without limitation, personal computers, laptops, notebook or tablet computers, touch pads, multi-touch devices, smart phones, personal digital assistants, other multi-function devices, stand-alone kiosks, etc. These, or any combination of these, may have utility in designing the physical components of the apparatus illustrated in the drawing figures, as well as in computing forces, stresses, strains, and expected life spans of given structural elements under a given set of assumptions and performance requirements.

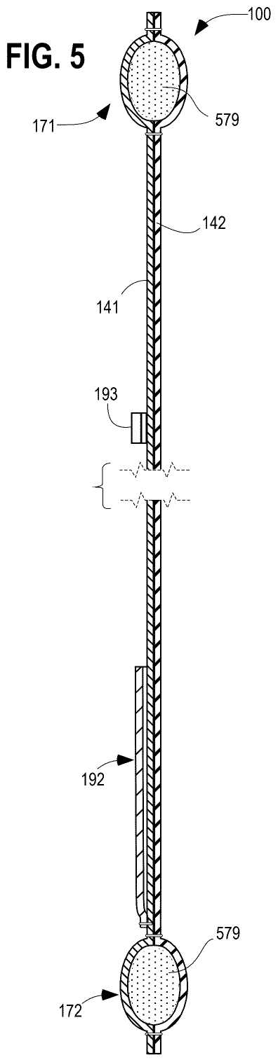

As noted above and as set forth in detail below, implementations of a beverage and accessory storage apparatus may be characterized in a sheet that is configured and operative to bear storage components oriented in such a position as to enable secure stowage of items in the storage components during use. In the context of the present disclosure, it is noted that the term “sheet” is intended to mean a layer or expanse of material or substrate that is generally planar or complanate in form and which defines an area to be employed to support the storage components described below. Those of skill in the art will readily appreciate that a sheet as illustrated and described may be a layer, tarpaulin, or other expanse of fabric, cloth, or other material such as, but not limited to, canvas, linen, cotton or cotton blends, polyester, nylon, vinyl, rubber, neoprene, plastics such as polyethylene, or a combination of these or other suitable materials to provide the operational characteristics set forth below. In some instances, rubber, plastics, or fibrous materials such as Kevlar™ or carbon fibers may be used for or interwoven into the structure of the sheet to add strength, ductility, impact resistance, ultra-violet radiation resistance, waterproofing, or other desired operational characteristic. In some implementations set forth below, it may be desirable that the disclosed sheet be embodied in or comprise two or more layers, each of a different material (see, e.g., the discussion of FIG. 5, below).

For example, a sheet as described herein may be made of or comprise water-resistant or waterproof material; in the case where the sheet is mainly fabricated of fabric or cloth such as canvas or linen, for example, the sheet may be coated or impregnated with a water-resistant or waterproof material such as polyurethane, rubber, neoprene, vinyl, or other suitable hydrophobic material or compound. In that regard, the sheet need not be a single layer of material, and may benefit in some applications from use of a soft, scratch- and slip-resistant layer (such as rubber, polyurethane, or neoprene) on one surface making contact with a vehicle or piece of furniture, on the one hand, and a waterproof and/or ultraviolet resistant layer (such as vinyl or polyethylene) on a second surface that is more exposed to the elements, on the other hand. The present disclosure is not intended to be limited by the nature of the materials used to construct the sheet, though it is noted that water resistance and slip resistance are both desirable qualities as will be appreciated from the description below.

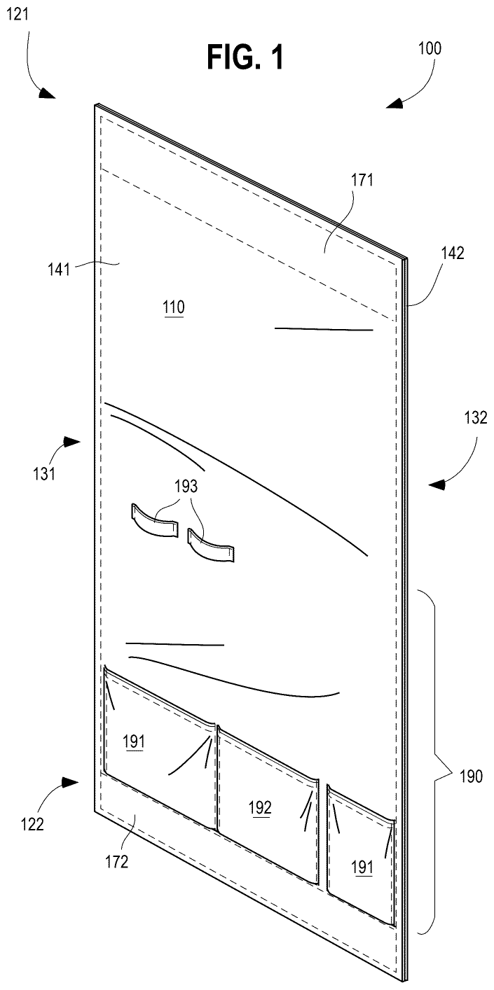

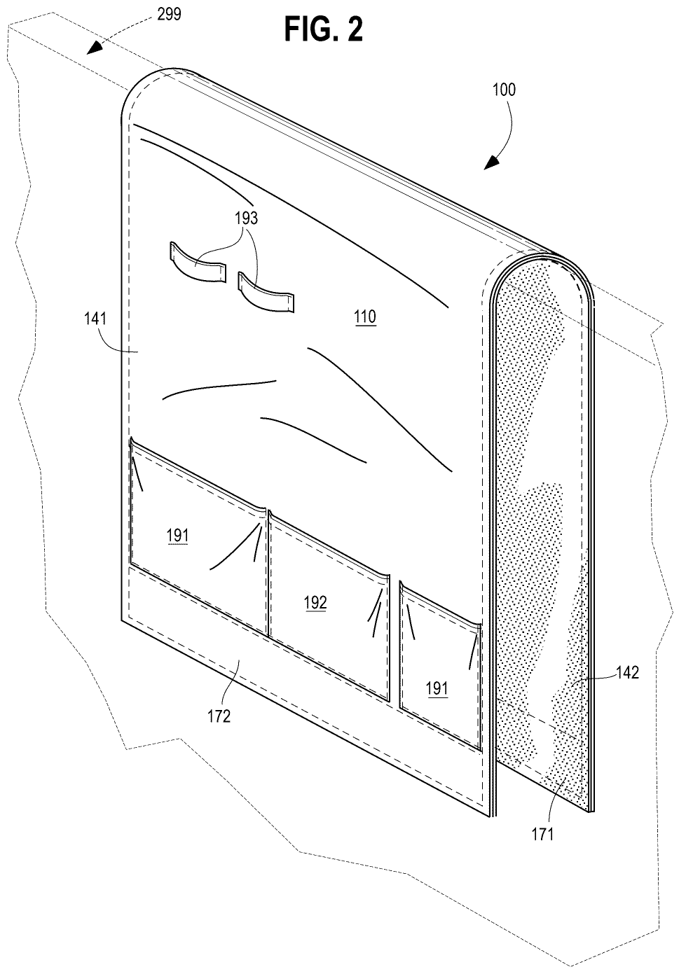

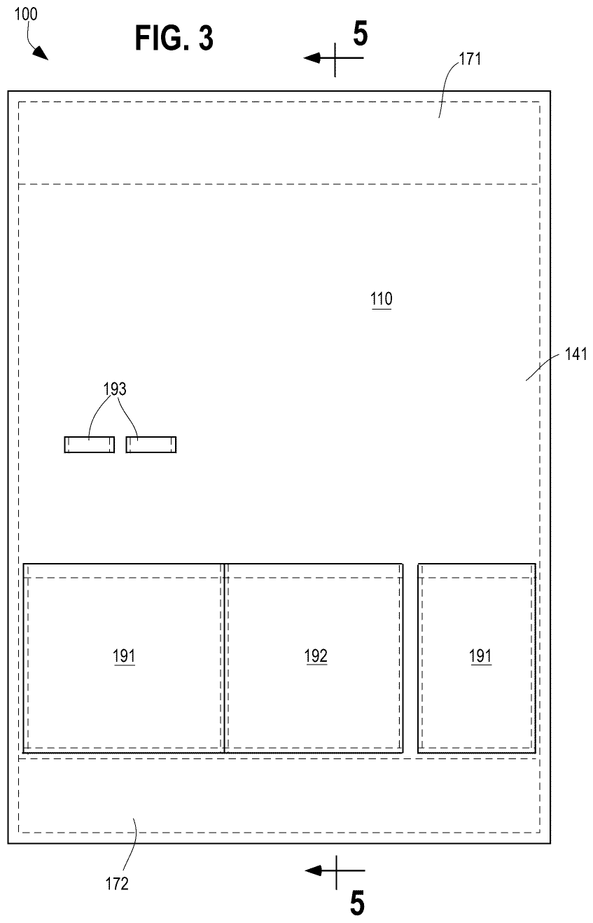

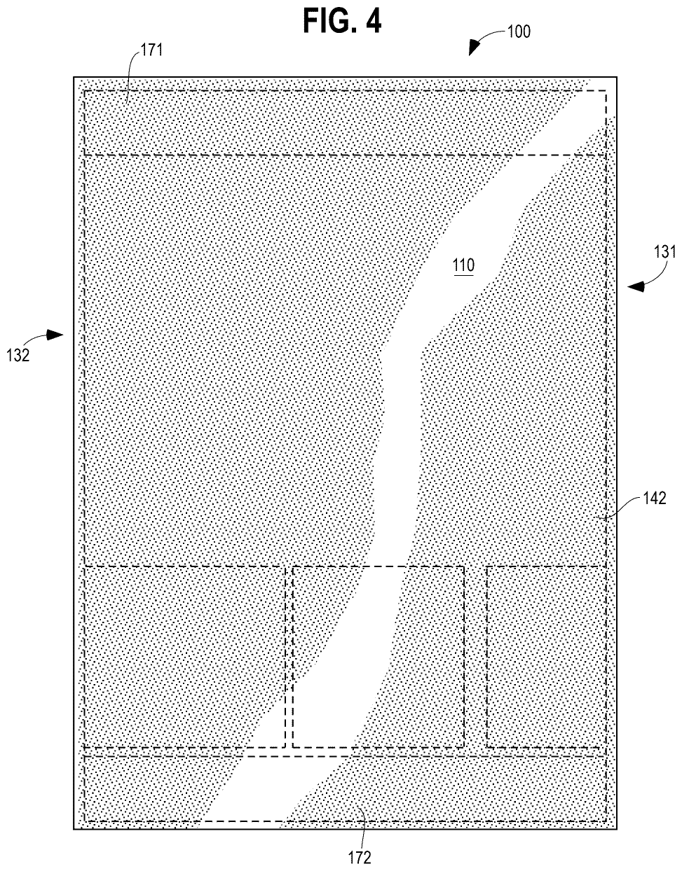

Turning now to the drawing figures, FIG. 1 is a perspective view of one implementation of a beverage and accessory storage apparatus in an extended state when not in use. Similarly. FIGS. 3 and 4 are a front elevation view and a back elevation view, respectively, of the apparatus of FIG. 1 illustrated in an extended state when not in use. On the other hand. FIG. 2 is a perspective view of the apparatus of FIG. 1 positioned for use in connection with an external structure.

As depicted in the example illustrated in FIGS. 1 through 4, a beverage and accessory storage apparatus 100 may generally comprise a flexible sheet of material (reference numeral 110) supporting storage components (generally depicted at reference numeral 190) and weighting components (reference numerals 171 and 172). Although sheet 110 is illustrated in FIGS. 1, 3, and 4 in an extended or generally planar orientation, in operation (see, e.g., FIG. 2), sheet 110 may be made to engage an external structure (such as a fence, railing, boat gunwale or transom, a vehicle bed rail, a tree branch, or the like) such that storage components 190 are positioned to secure beverages or other contents while still enabling ready access to same. This external structure (depicted in phantom and identified by reference numeral 299 in FIG. 2) may be any structure over which sheet 110 may be laid, draped, or otherwise disposed upon substantially as set forth herein. In some instances, it may be desirable that one end of sheet 110 is disposed on one side of structure 299, while a second end of sheet 110 is disposed on the other side, such as illustrated in FIG. 2, though this is not strictly necessary. For instance, implementations of apparatus 100 may be so sized and dimensioned as to engage a variety of structures 299, even those having large or irregular surfaces such as boulders, ledges, roofs, or other structure; i.e., apparatus 100 may have utility even in connection with some structures 299 having surfaces that are larger than a span of sheet 110.

In the drawing figures, sheet 110 is illustrated as having opposing top and bottom ends (reference numerals 121 and 122, respectively) and opposing left and right sides (reference numerals 131 and 132, respectively). As noted above, sheet 110 may be a generally flat, planar, or complanate expanse of material in any of a variety of different shapes (as described below), but in any case generally defining a front surface and a back surface (reference numerals 141 and 142, respectively). In this context, it will be appreciated that the terms “top,” “bottom,” “left,” “right,” “front,” and “back” are relative (provided only by way of simplifying the following description), and may change with a selected orientation of sheet 110 or an angle from which apparatus 100 is viewed (either during use or otherwise); see, e.g., the back elevation view of FIG. 4, in which “left” and “right” sides are reversed.

As set forth herein, sheet 110 may generally be characterized as a suitably flexible substrate having structural qualities substantially as described above, and may be constructed of or comprise cloth (such as linen, canvas, felt, cotton, or other textile materials), synthetic fabrics or layers (such as nylon, polyester, vinyl, and the like), or other engineered fibrous materials or layers (such as Kevlar™ or carbon fibers). Rubber, polyethylene or other plastics, and other water-resistant or waterproof materials may be layered in or on or otherwise incorporated into a structure of sheet 110 as is generally known in the art. As set forth in more detail below, it may generally be desirable that sheet 110 is implemented to be ruggedized (or “tough”) enough to withstand being driven over (e.g., by a vehicle or trailer) and to resist impacts from falling, wind-blown, and water-borne debris during periods of inclement weather or rough seas, flexible or pliant enough to be folded over the top of vehicle or furniture structural components such as structure 299 (and to be rolled or wadded up when not in use), and sufficiently water-resistant or waterproof to prevent or delay material deterioration due to exposure to rain, sea water, fog, and other moisture sources.

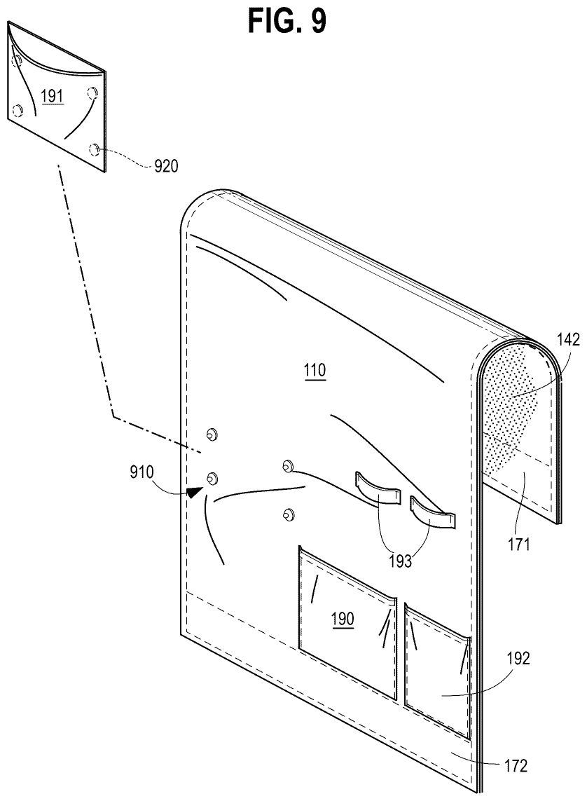

Sheet 110 may support a variety of storage components generically depicted at reference numeral 190; FIGS. 1 through 3 illustrate one arrangement of storage components 190 disposed on front surface 141 by way of example only, and not by way of limitation (see, e.g., FIGS. 9 through 12). In some implementations, storage components 190 may be embodied in or comprise cup, can, bottle, carafe, or other beverage holders (reference numeral 191), pockets, which may be selectively closable or sealable, suitable for stowing wallets, keys, wireless telephones, and the like (reference numeral 192), or an array of loops, rings, or chain links for carrying or otherwise dangling small tools, key rings, carabineers, or other items that are amenable to hanging such as by hooks, handles, cables, jump rings, or the like (reference numeral 193).

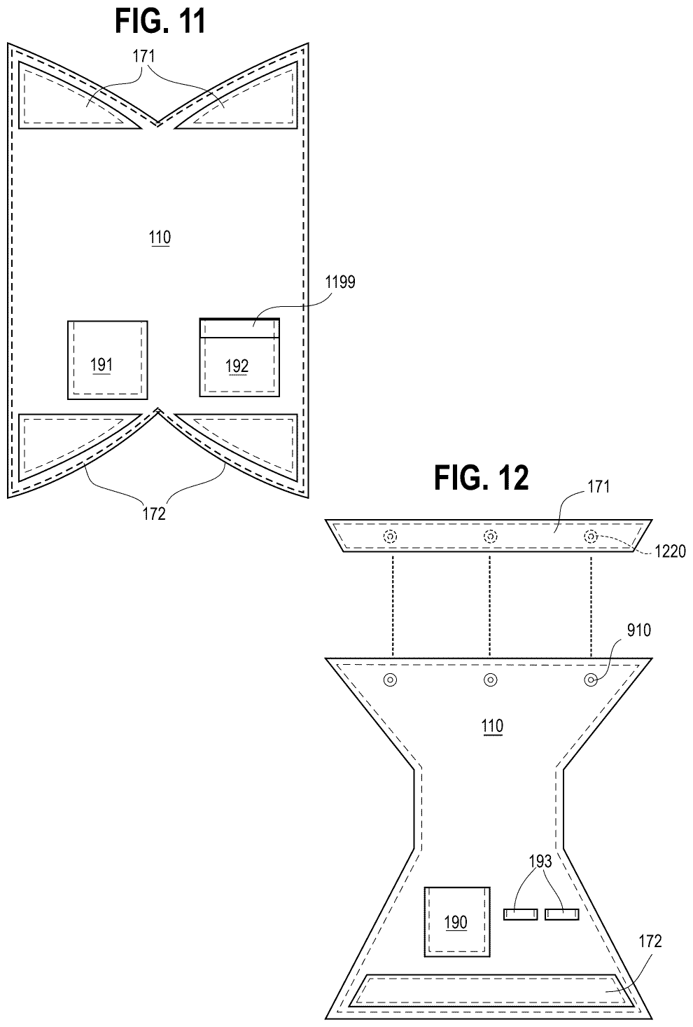

It will be appreciated that storage components 190 may be fabricated of the same materials as noted above in connection with sheet 110, or of different materials, depending upon an intended use or application of apparatus 100. For instance, cup holders 191 may be made of the same water-resistant nylon fabric as sheet 110 (if applicable and desired), or they may be made of neoprene or a rubberized material for better temperature insolation of cool or hot beverages, even in the event that sheet 110 is not so constructed. Additionally or alternatively, cup holders 191, pockets 192, or both may be made of a more elastic material than that used for sheet 110 to facilitate expansion and a snug fit of the contents intended to be secured. In the case that pocket 192 is intended to secure wireless telephones or other portable electronics, it may be desirable that its construction is waterproof, or at least as water-resistant as possible, even in the event that sheet 110 is not. In that regard, these and other storage components 190 may include elastic bands or stretchable elements, zippers, or other closures or restrictive components (see, e.g., reference numeral 1199 in FIG. 11) to close or constrict openings, so as to limit unintended shifting or removal of contents due to vibration, vehicle motion, or slippage of sheet 110 during use, and to prevent or minimize water intrusion, if so desired. In the case of certain storage components 190 having generally closed bottoms to contain items (such as cup holder 191 or pocket 192), it may be desirable that these storage components 190 are made of breathable or mesh material, or are otherwise supplied with slots, slits, perforations, or other apertures which may allow water or moisture introduced into the interior (such as rain, sea water, or condensation) to escape. In the case of loop storage components 193, these may be constructed of cord (such as nylon, hemp, or other textiles), wire (such as coated, bare, treated, or anodized stainless steel, copper, or bronze), or metal bands, generally as a design choice and a function of intended use.

The present disclosure is not intended to be limited by any particular material or combination of materials used for construction of sheet 110, storage components 190, or weighting components 171,172 (described below). In particular, it is contemplated that any material suitable for outdoor use and exposure to the elements may be employed for these elements, and as for storage components 190, it is also noted that the specific material for a given application may be selected as a function of weather resistance, intended life span, cost, material strength, and the manner in which a particular storage component 190 is supported by sheet 110 (as described below).

Specifically, one or more storage components 190 may be integrated with, or otherwise permanently attached or secured to, a structure of sheet 110. This may be accomplished via stitching, adhesives, fabric rivets or other permanent fastening members, or by employing a combination of these and other methods of fabric article manufacture that are generally known in the art. Additionally or alternatively, some or all of storage components 190 may be removably attached or affixed to sheet 110, facilitating dynamic customization of apparatus 100 as needs or applications vary. This may be accomplished via specific fastening elements (see, e.g., reference numeral 910 in FIG. 9) integrated at particular or predetermined locations on sheet 110, on the one hand, and cooperating or mating fastening elements (see, e.g., reference numeral 920 in FIG. 9) incorporated into selectively removable storage components 190, on the other hand. While not illustrated in detail in the drawing figures for clarity, a variety of fastening elements may be suitable or otherwise have utility for this purpose of selectively securing a storage component 190 to front surface 141 of sheet 110. By way of example, such cooperating fastening elements may be implemented as grommets and opposing strings or clasps, snaps, zippers, opposing buttons and button holes, hook and loop fasteners, or any other fastening mechanisms or cooperating structures generally known in the art or developed in accordance with known principals. As will be appreciated, it may be desirable to manufacture, construct, or otherwise to fabricate the opposing and cooperating structures of such fastening elements 910 of silicon, rubber, plastic, fabric, or other relatively soft or non-abrasive materials that are both weather resistant and configured and operative not to scratch, abrade, mar, or otherwise damage a surface finish or glass, metal, or other structural components of any surface upon which apparatus 100 is to bear or may contact during use. In any case, those of skill in the art will appreciate that such fastening elements 910 may be designed and operative selectively to secure an otherwise removable storage component 190 at a selected location on front surface 141 of sheet 110 during use.

FIGS. 1 through 4 also illustrate weighting components 171 and 172 that may be integrated with or otherwise attached or secured to a structure of sheet 110, with top weighting component 171 disposed proximate to top end 121, and bottom weighting component 172 disposed proximate bottom end 122; as noted above, the terms “top” and “bottom” are relative terms, and there may be applications in which top weighting component 171 is actually lower (in an elevation or side view) than bottom weighting component 172 during use, due to the geometry of apparatus 100 and the surface upon which sheet 110 is made to bear. During use (see FIG. 2), each respective weighting component 171,172 may be disposed on a respective opposing side of external supporting structure 299 (such as a wall, fence, railing, etc.), and the combined weight of these elements serves to secure sheet 110 in position under a gravity load.

In their simplest form, weighting components 171,172 may be implemented as sealed pockets, running substantially the width of sheet 110 (i.e., from left side 131 to right side 132), which contain a relatively dense material generally to be used as ballast (see reference numeral 579 in FIG. 5). In such an arrangement, weighting components 171,172 may be filled with ballast material 579 generally embodied in or comprising sand or gravel, for instance, although other materials may be used. Marbles, scraps or pellets of metal, sawdust, clay, and even water or other liquids may also be used as ballast material 579, as well as a combination of these or other materials (e.g., wet sand is generally more dense than dry sand). Weighting components 171,172 containing such ballast material 579 may be permanently sealed and integrated with a structure of sheet 110 such as via stitching, adhesives, fabric rivets, or a combination of these and other devices or methods generally known in the art.

Given the role of weighting components 171,172 in weighing down or otherwise encumbering apparatus 100 to prevent unwanted movement of sheet 110 during use, it will be appreciated that the relative sizes, shapes, and locations of weighting components 171,172 may be susceptible of many variations, and may be application-specific and dependent upon a variety of factors such as ballast material 579 (specifically, its density) used for providing weight inside weighting components 171,172, the dimensions and material used for sheet 110, the intended use of apparatus 100 in wind-whipped environments, or a combination of these and perhaps other factors.

In some implementations, it may be desirable that ballast material 579 in one or both of weighting components 171,172 include magnetic material (such as a magnetic bar or other mass). In this arrangement, not only will weight concentrated in weighting components 171,172 act as ballast to prevent unwanted movement of sheet 110, but the magnetic nature of ballast material 579 may also create a magnetic force in the presence of ferrous materials such as may be found in truck beds, certain boat or canoe hulls, fence rails, and the like; care should be taken, in this instance, not to employ apparatus 100 in a manner that might affect reliable operation of magnetic compasses or other sensitive electronic equipment. Similarly, weighting components 171,172 may be implemented with closures, such as zippers, hook and loop fasteners, or other resealable mechanisms, facilitating selective removal and replacement of ballast material 579 within; in this arrangement, relative weight of weighting components 171,172 may be modified or adjusted as desired or necessary for a given application, and weighting components 171,172 may be entirely evacuated for storage when apparatus 100 is not in use, and refilled on-site when needed. In this arrangement, the type of closure or sealing technology may affect the type of ballast material 579 that may be reliably contained in weighting components 171,172 (for instance, unless the seal is water-tight, it may not be possible to use water as ballast material 579).

As discussed above with reference to storage components 190, it may be desirable in some instances that one or both of weighting components 171,172 may be implemented as selectively removable, in which case, similar cooperating fastening elements (see, e.g., reference numerals 910 and 1220 in FIG. 12) may be used selectively to attach weighting components 171,172 to sheet 110, for example, via buttons, zippers, hook and loop fasteners, and the like (though in this case, weighting components 171,172 may also be attached to back surface 142 of sheet 110, if desired). In such arrangements (see, e.g., FIG. 12), weighting components 171,172 may be swapped with each other, for instance, or replaced by heavier (or lighter) versions, or by versions having different shapes or that are placed in different locations in relation to each other or to sheet 110, as a function of a particular application. For example, magnetic weighting components 171,172 may be stored on a boat for use in connection with a metallic gunwale, while sand-filled weighting components 171,172 may be stored in a tent for using in connection with non-ferrous chairs or fences during camping trips.

FIG. 5 is a cross-sectional view of the apparatus of FIG. 1 taken on the line 5-5 in FIG. 3. In the FIG. 5 arrangement, it can be seen that weighting components 171,172 are integrated with a structure of sheet 110, which generally comprises a first layer of material defining front surface 141 and a second layer of material defining back surface 142. As indicated by the different hashing patterns, the materials selected for front surface 141 and back surface 142 may differ as a function of design choice or as desired, taking into consideration overall operational characteristics of apparatus 100 and the environment in connection with which it is intended to be used.

For example, in some applications, it may be desirable that a first layer defining front surface 141 be embodied in or comprise water-resistant or waterproof material such as nylon, Gore-Tex™, or natural cloth that is coated or impregnated with a water-resistant or waterproof material such as polyurethane, rubber, neoprene, vinyl, or other suitable hydrophobic compound, while the second layer defining back surface 142 be embodied in or comprise rubber, polyurethane, neoprene, textured silicone or plastics, or other soft, scratch- or slip-resistant material, as noted above. It will be appreciated that any of various combinations of these materials may be selected for materials of sheet 110, and other factors (such as pliability or elasticity, resistance to ultraviolet radiation, mildew, and mold, and toughness or tear resistance) may also be taken into account.

It is also noted that the cross-section of FIG. 5 is simplified in some ways, and provided by way of example only, and not by way of limitation. For instance, in the illustrated arrangement, storage components 190 (such as loop storage component 193 and pocket 192) are shown as integral with sheet 110 or fixedly attached to front surface 190, though the intricacies of these attachments (such as stitching and fabric rivets) are omitted for clarity. Similarly, ballast 579 is illustrated as being disposed between front surface 141 and back surface 142, but the particular implementation of ballast 579 material vis-à-vis various layers of sheet 110 is susceptible of many variations. In that regard, sheet 110 itself may comprise more than two layers in some situations, or more layers may be deployed at particular locations, such as at attachment points for selectively removable storage components 190 or weighting components 171,172 (see, e.g., FIGS. 9 and 12). Various alternative arrangements will be apparent to those of skill in art, and may have utility in connection with a given application or use of apparatus 100.

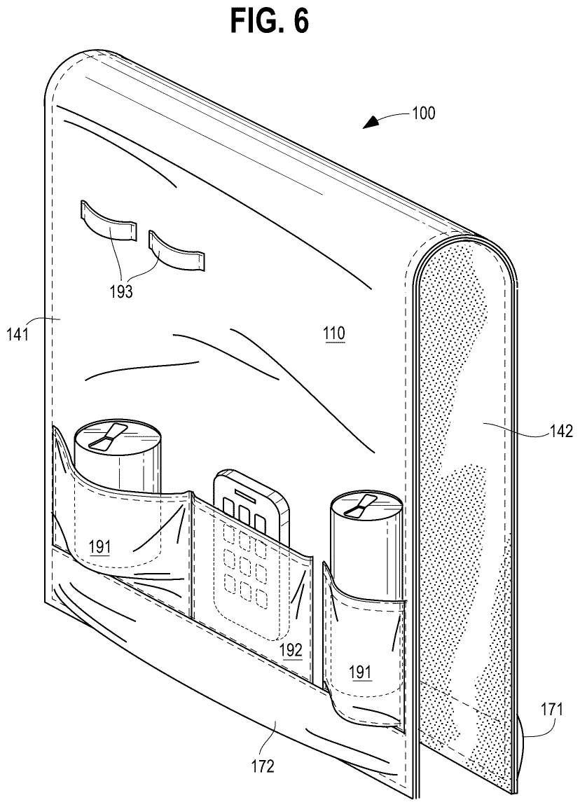

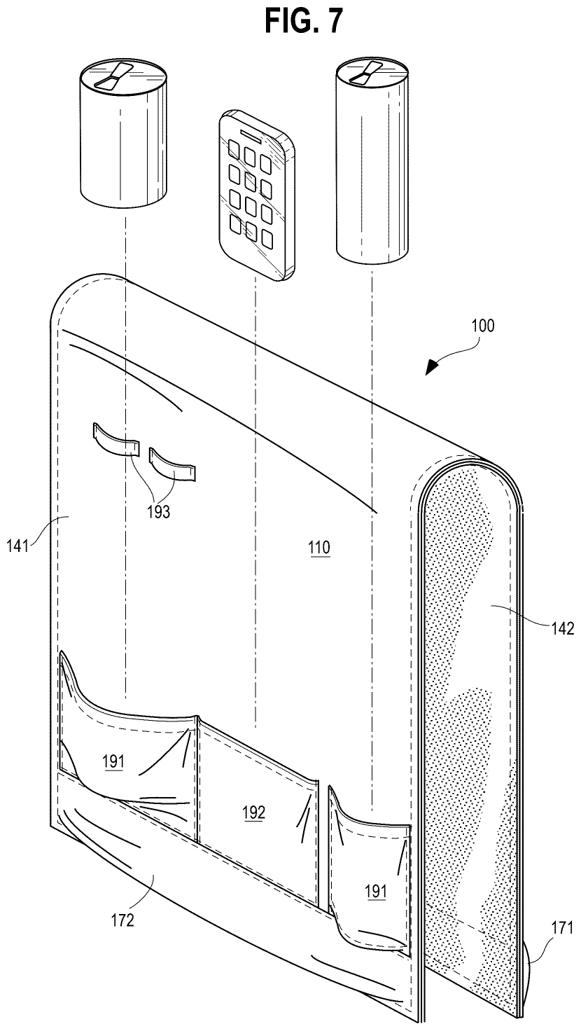

FIG. 6 is a perspective view of the apparatus of FIG. 1 in use in connection with an external structure (not shown), and also depicting various items that may be stored, and FIG. 7 is a partially exploded perspective view of the apparatus of FIG. 6 and the various items that may be stored. In this particular example, beverage cans are stowed in cup holders 191, and a personal electronic device is stowed in pocket 192. Of note in FIGS. 6 and 7, as compared to FIGS. 1 and 2, is the expansion (away from front surface 141) of cup holders 191 and pocket 192 to accommodate the volume occupied by the cans and the electronic device, respectively. Though not shown for clarity, hanging or dangling items such as key chains, screwdrivers, snippers or other tools for tying flies for fishing, and other small items (for example) may be accommodated by loop storage components 193.

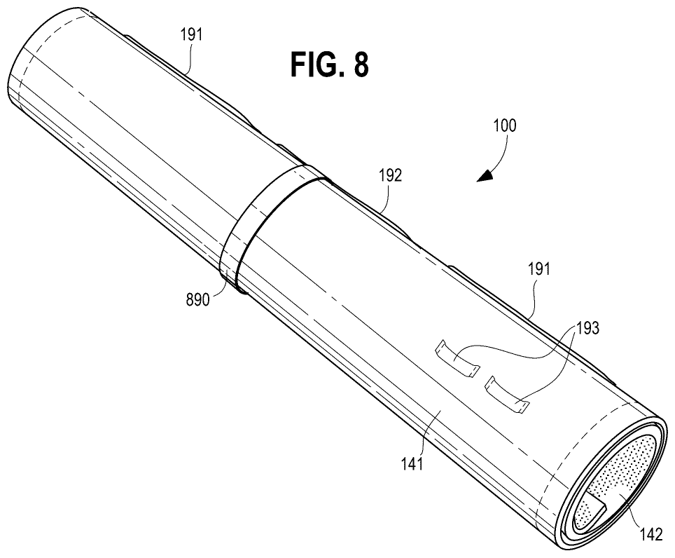

FIG. 8 is a perspective view of the apparatus of FIG. 1 illustrated in a state suitable for storage. In this arrangement, it will be appreciated that apparatus 100 is rolled, with front surface 141 facing outward (note visibility of cup holders 191 and pocket 192) and back surface 142 facing inward towards the interior of the tubular shape formed as sheet 110 is rolled. A fastening element (reference numeral 890) may be provided to secure sheet 110 in this configuration when apparatus 100 is not in use. In some implementations, it may be desirable to construct fastening element 890 as grommets or eyelets disposed on one end (say, top end 121) of sheet 110, with cooperating strings, straps, ropes, or cables disposed on the same end of sheet 110 (so as to be accessible after sheet 110 is rolled); in this arrangement, a strap or rope may be wrapped around the rolled sheet 110, threaded through a grommet, and secured to prevent sheet 110 from unrolling when apparatus 100 is not in use. Perfect alignment and accurate rolling of sheet 110 may not be necessary during storage of apparatus 100, as any variations in the manner in which sheet 110 is rolled may be accommodated by appropriately dimensioned ropes, straps, or cables associated with fastening element 890.

Alternatively, fastening element 890 may be implemented as hook and loop fasteners, buttons, snaps, or any of the other fastening mechanisms or cooperative structures described herein with reference to selectively attachable storage components 190 and weighting components 171,172. As noted above, irrespective of the specific structures employed, it may be desirable that fastening element 890 be embodied in or comprise non-abrasive materials so as not to scratch, abrade, mar, or otherwise damage a surface with which apparatus 100 may make contact (even when not in use).

FIG. 9 is a perspective view of another implementation of a beverage and accessory storage apparatus positioned for use in connection with an external structure (not shown), and also illustrating a selectively attachable storage component. In this partially exploded view, it can be seen that cup holder 191 may be selectively removable and selectively attachable, such as at fastening elements (reference numeral 910) via cooperating fastening elements (reference numeral 920). As noted above, selectively removing, replacing, swapping, or attaching a storage component 190 such as cup holder 191 to sheet 110 may enable or facilitate dynamic customization of apparatus 100 for a variety of applications. In some implementations, fastening elements 910, which may be integrated at particular or predetermined locations on sheet 110, may cooperate or mate with counterpart fastening elements 920 incorporated into selectively removable storage components 190, such as cup holder 191 in FIG. 9. In the illustrated example, fastening elements 910 are depicted as snaps (which may press-fit or friction-fit to engage reciprocal fastening elements 920 on cup holder 191), but any of various cooperating fastening mechanisms may be employed for this purpose, such as grommets and opposing strings or clasps, buttons and cooperating button holes, zippers, hook and loop fasteners, and the like. As noted above, it may be desirable to manufacture, construct, or otherwise to fabricate the opposing and cooperating structures of such fastening elements 910 and 920 of silicon, rubber, plastic, fabric, or other relatively soft or non-abrasive materials.

Also of note in FIG. 9 are the overall dimensions of apparatus 100, in general, and the manner in which it may engage a supporting exterior structure (such as structure 299 in FIG. 2). As compared to the example of FIG. 2, the apparatus 100 in FIG. 9 does not extend as far down (in the vertical direction) on the far side of the supporting external structure during use. The FIG. 9 embodiment may be suitable for use on canoes, skiffs, or other waterborne craft with low freeboards (i.e., the vertical distance from the waterline to the top of the gunwales or transom), as well as for other applications such as lounge chairs with low arms or bolsters. In this case, the amount or density of ballast 579 used in weighting component 171 may be selected or dynamically adjusted to take into account the specific geometry of apparatus 100 and its intended or necessary drape over the external structure.

Finally, it will be appreciated that the arrangement of storage components 190 is different in FIG. 9 than that illustrated in the earlier drawing figures. As noted above, specific numbers, locations, and purposes of storage components 190, as well as their sizes, shapes, and respective functionalities, may vary as desired or as a function of a given application selected for apparatus 100. Some possibilities are provided below by way of example only, and not by way of limitation.

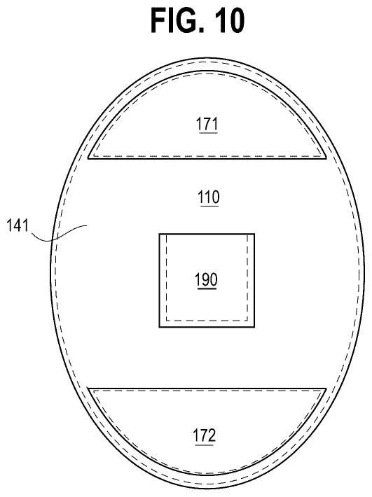

Specifically, FIGS. 10 through 12 are front elevation views of several implementations of a beverage and accessory storage apparatus in an extended state when not in use, and also illustrating various shapes, alternatives, and component configurations.

In the FIG. 10 arrangement, sheet 110 is implemented in an elliptical shape, though ovals, rounded rectangles, and even squares or circles are also contemplated. Depending upon the width of sheet 110, it may be desirable only to include a single storage component 190 (or storage component attachment point such as with fastening elements 910), making this shape potentially optimized for convenient personal use.

It is noted that, given the geometry of apparatus in FIG. 10, some of the mass of ballast 579 (in weighting components 171,172) may be distributed further from the point at which sheet 110 flexes at the exterior structure (such as structure 299), such that less mass is needed, or more force is applied to sheet 110 during use, than in a rectangular configuration of similar dimensions.

In the FIG. 11 arrangement, sheet 110 is implemented in a “butterfly” or “double swallowtail” shape. This configuration may allow for separation of each respective weighting component 171 and 172 into different “left” and “right” subsections, each of which may be weighted with ballast 579 as desired for different applications. Also of note in FIG. 11 is the addition of a closable flap 1199 at a top portion of pocket 192—this may prevent loss of items stored therein. It will be appreciated that flap 1199 may be left to close freely under its own weight, or it may be facilitated by snaps, zippers, buttons, or hook and loop fasteners, for instance, to prevent pocket 192 from opening unintentionally, even in unpredictable orientations (such as during rough seas or in the event that sheet 110 is buffeted by high winds). Again, the locations and arrangement of storage components illustrated in FIG. 11 is different from those illustrated in the earlier drawing figures.

In the FIG. 12 arrangement, sheet 110 is implemented in an “hourglass” shape, which may or may not be symmetrical. In this implementation, the narrow portion of sheet 110 (e.g., at the “waist” of the hourglass) may minimize the amount of material used, making apparatus 100 generally lighter and easier to transport, and potentially more economical to manufacture, than a rectangular configuration of similar dimensions.

The FIG. 12 implementation also depicts a weighting component 171 that is selectively attachable and selectively removable at fastening elements 910 via cooperating fastening elements (reference numeral 1220); in some instances, it may be desirable that weighting component 172 is also selectively attachable in the same or similar manner. As noted above, this feature may facilitate customizable weighting options for various applications of apparatus 100, and may allow for a magnetic ballast 579 to be swapped for a non-magnetic material, or vice-versa, among other possibilities.

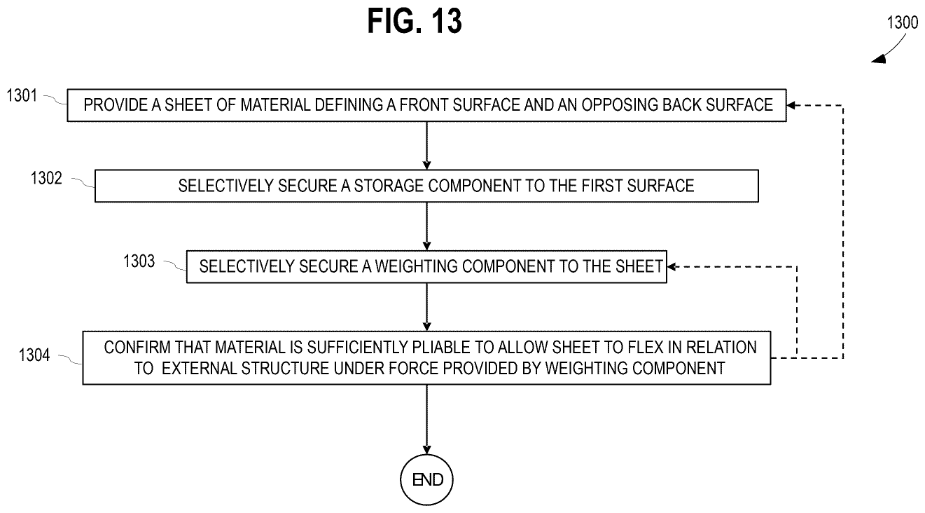

FIG. 13 is a simplified functional flow diagram illustrating aspects of one implementation of a method of fabricating a beverage and accessory storage apparatus. In accordance with some implementations, a method 1300 of fabricating such an apparatus (such as apparatus 100) may begin by providing a sheet of material (such as sheet 110) defining a front surface (such as front surface 141) and a back surface (such as back surface 142), the back surface opposed to the front surface, as indicated at block 1301.

As indicated at block 1302, a storage component (such as those indicated, generally, by reference numeral 190, and, more particularly, by reference numerals 191 through 193) may be selectively secured to attached to the first surface. During manufacture, this may be accomplished by rigidly or fixedly attaching the storage component to the front surface, or by otherwise integrating the storage component into the structure of the sheet; additionally or alternatively, this may be accomplished by integrating fastening elements (such as reference numeral 910) into the sheet, such that a selectively attachable storage component may be subsequently attached or affixed to the fastening elements substantially as set forth above. In either event, the storage component or the attendant fastening elements may be secured to or integrated with the sheet at a location selected to position an item to be stored in a predetermined orientation during use of the apparatus.

The method may continue by selectively securing a weighting component (such as weighting components 171,172) to the sheet as indicated at block 1303. As noted above, this may include attaching a weighting component to the front surface (see, e.g., FIG. 12) or the back surface, or it may include integrating a structure of the weighting component with a structure of the sheet itself (see, e.g., FIG. 5). In either event, the weighting component may be placed at a location selected to provide a force to the sheet when the back surface is made to bear on an external structure during use. It is noted that the material used to provide this weight (e.g., ballast 579 in the drawing figures) may be selected to have sufficient density to perform this function, given the overall geometry of the apparatus as well as the volume and positioning of the weighting component.

In that regard, it is noted that the apparatus is intended to drape over or otherwise to flex in relation to an external structure upon which the back surface of sheet is placed during use. A determination may be made (e.g., at block 1304) that a material selected for the sheet is sufficiently pliable to allow the sheet to flex in relation to the external structure under the force provided by the weighting component. The dashed arrows in FIG. 13 are meant to be an indication that, in the event that the sheet is not sufficiently pliant, it may be desirable to employ a different material (e.g., the loop back to block 1301) or to change the size, location, or ballast material used for the weighting component (e.g., the loop back to block 1303). Where the sheet is sufficiently pliable to satisfy the requirement of the apparatus as a whole, the method ends as indicated at the bottom of FIG. 13.

It is noted that the arrangement of the blocks and the order of operations depicted in FIG. 13 are not intended to exclude other alternatives or options. For example, the operations depicted at blocks 1301 and 1304 may be reversed in order, or they may be made to occur substantially simultaneously in some implementations. In some situations, it may be desirable to intertwine the operations depicted at blocks 1303 and 1304 with some of the operations depicted at block 1302, for instance, to optimize dimensions and locations of the various components. It may also be desirable to iterate the operation at block 1301 such that a sheet may be built of multiple layers (which may or may not be of identical or similar materials). Those of skill in the art will also appreciate that the operations depicted at blocks 1302 and 1303 may be occurring substantially simultaneously as well, and that the foregoing subject matter is susceptible of various design choices that may influence the order or arrangement of the operations depicted in FIG. 13.

Several features and aspects of a beverage and accessory caddy, as well as systems and methods of fabricating same, have been illustrated and described in detail with reference to particular embodiments, arrangements, or implementations by way of example only, and not by way of limitation. Those of skill in the art will appreciate that alternative implementations and various modifications to the disclosed subject matter are within the scope and contemplation of the present disclosure. Therefore, it is intended that the present disclosure be considered as limited only by the scope of the appended claims.

1. An apparatus comprising:
a sheet of material having a top end, a bottom end opposed to the top end, a left side, and a right side opposed to the left side, the sheet defining a front surface and a back surface, the back surface opposed to the front surface and operative to engage an external structure during use of the apparatus;
a storage component disposed at a location on the front surface proximate to the bottom end and operative selectively to store an item during use of the apparatus; and
a weighting component disposed proximate to one of the top end or the bottom end and operative to provide a force to the sheet when the back surface is made to bear on the external structure;
wherein the sheet is sufficiently pliable to flex in relation to the external structure under the force provided by the weighting component.

2. The apparatus of claim 1 wherein a material used for the sheet comprises one of cloth, synthetic fabric, composite material, rubber, or a synthetic rubber.

3. The apparatus of claim 1 wherein the sheet comprises more than one layer of material.

4. The apparatus of claim 3 wherein the back surface comprises a slip-resistant material.

5. The apparatus of claim 4 wherein the front surface comprises a synthetic fabric material.

6. The apparatus of claim 1 wherein the storage component is sized and dimensioned to accommodate a beverage container.

7. The apparatus of claim 6 wherein the storage component comprises an insulating material.

8. The apparatus of claim 6 wherein the storage component comprises a mesh material.

9. The apparatus of claim 1 wherein the weighting component extends substantially from the left side to the right side of the sheet.

10. The apparatus of claim 1 wherein one of the storage component and the weighting component is selectively removable.

11. The apparatus of claim 1 wherein the sheet is substantially rectangular in a front elevation view.

12. The apparatus of claim 1 wherein the sheet is substantially elliptical in a front elevation view.

13. An apparatus comprising:
a sheet of material having a top end, a bottom end opposed to the top end, a left side, and a right side opposed to the left side, the sheet defining a front surface and a back surface, the back surface opposed to the front surface and operative to engage an external structure during use of the apparatus;
a storage component disposed at a location on the front surface proximate to the bottom end and operative selectively to store an item during use of the apparatus; and
a first weighting component disposed proximate to the top end and a second weighting component disposed proximate to the bottom end, the first and second weighting components, respectively, operative to provide a respective force to the sheet when the back surface is made to bear on the external structure;
wherein the sheet is sufficiently pliable to flex in relation to the external structure under the respective force provided by each of the respective first and second weighting components.

14. The apparatus of claim 13 wherein a material used for the sheet comprises one of cloth, synthetic fabric, composite material, rubber, or a synthetic rubber.

15. The apparatus of claim 14 wherein the back surface comprises a slip-resistant material.

16. The apparatus of claim 13 wherein the storage component is sized and dimensioned to accommodate a beverage container.

17. The apparatus of claim 13 wherein one of the first weighting component and the second weighting component extends substantially from the left side to the right side of the sheet.

18. The apparatus of claim 13 wherein one of the storage component, the first weighting component, and the second weighting component is selectively removable.

19. The apparatus of claim 1 wherein the sheet is substantially rectangular or elliptical in a front elevation view.

20. A method of fabricating a storage apparatus, the method comprising:
providing a sheet of material defining a front surface and a back surface, the back surface opposed to the front surface;
selectively securing a storage component to the first surface at a location selected to position an item to be stored in a predetermined orientation during use of the apparatus; and
selectively securing a weighting component to the sheet at a location selected to provide a force to the sheet when the back surface is made to bear on an external structure;
wherein the providing a sheet comprises selecting a material that is sufficiently pliable to allow the sheet to flex in relation to the external structure under the force provided by the weighting component.
